(19) United States
(12) Patent Application Publication
(10) Pub. No.: US 2024/0375486 A1
(43) Pub. Date: Nov. 14, 2024

(54) HEAT EXCHANGER FOR A COOLANT LOOP

(71) Applicant: VALEO SYSTEMES THERMIQUES, La Verriere (FR)

(72) Inventors: Gael DURBECQ, La Verriere (FR); Jeremy BLANDIN, La Verriere (FR); Kamel AZZOUZ, La Verriere (FR)

(73) Assignee: VALEO SYSTEMES THERMIQUES, La Verriere (FR)

(21) Appl. No.: 18/688,138

(22) PCT Filed: Jul. 29, 2022
(86) PCT No.: PCT/EP2022/071420

§ 371 Date: Feb. 29, 2024

(30) Foreign Application Priority Data
Sep. 3, 2021 (FR) FR2109218

(51) Int. Cl. B60H 1/32

(52) U.S. Cl. CPC B60H 1/32284; B60H 1/3227

(57) ABSTRACT

The present invention primarily relates to a heat exchanger including a heat-exchange surface intended to be traversed by an air flow including at least one four-way valve that is able to adopt a first position in which the four-way valve fluidically connects one of the inlet orifices of a first inlet manifold to an inlet line and one of the outlets of a second outlet manifold to an outlet line, and at least a second position in which the four-way valve fluidically connects one of the inlet orifices of the first inlet manifold to the outlet line and one of the outlets of the second outlet manifold to the inlet line.

### TECHNICAL FIELD

The present invention relates to the field of heat exchangers for a coolant loop for a vehicle, notably a motor vehicle, and more specifically for hybrid or electric vehicles.

### BACKGROUND OF THE INVENTION

Such coolant loops are intended to circulate a coolant, notably as part of a vehicle heating, ventilation and/or air-conditioning installation. These coolant loops use a heat exchanger to modify the temperature inside the passenger compartment of the vehicle. This temperature modification inside the passenger compartment is notably caused by the circulation of a coolant in the coolant loop between a heat-exchange device arranged in the passenger compartment of the vehicle and a heat exchanger arranged in contact with the ambient air on the front face of the vehicle. Thus, the coolant circulating in the coolant loop absorbs or cedes calories in the heat exchanger or the heat-exchange device depending on the cooling or heating requirements of the passenger compartment.

The heat exchanger on the front face of the vehicle enables the exchange of calories between the coolant and an air flow traversing this heat exchanger. One of the problems with such a heat exchanger is that ice can form on the heat exchanger as a result of direct exposure of the heat exchanger to the outside air when the outside temperature is low and the humidity level of the outside air is high. This is because contact between the cold wet outside air flow and the cold coolant entering the heat exchanger causes the water vapor contained in the air flow to freeze on the heat exchanger. Such icing of the heat exchanger generates additional thermal resistance between the air flow and the coolant and tends to hinder the air flow through the heat exchanger. Ice therefore tends to reduce the heat exchange capacity of the heat exchanger installed on the front face when the coolant loop is used in heating mode to heat the passenger compartment.

### SUMMARY OF THE INVENTION

The present invention is intended to overcome this drawback by proposing a heat exchanger that limits the formation of ice on said heat exchanger, and that is small. The invention therefore helps to increase the heat-exchange capacity of the heat exchanger, and in particular the coolant loop.

In this context, the present invention primarily relates to a heat exchanger for a coolant loop, comprising a heat-exchange surface, the heat exchanger comprising a first heat-exchange circuit including a first inlet manifold and a first outlet manifold between which a first set of tubes extend longitudinally, the first inlet manifold participating in delimiting at least two collector chambers, each of which is fed through at least one inlet orifice, the first outlet manifold comprising at least one outlet orifice, the heat exchanger comprising a second heat-exchange circuit including a second inlet manifold and a second outlet manifold between which a second set of tubes extend longitudinally, the second inlet manifold comprising at least one inlet, the second outlet manifold participating in delimiting at least two collector cavities, each opening into at least one outlet, the tubes of the first set of tubes being stacked alternately with the tubes of the second set of tubes, the heat exchanger comprising a coolant inlet line and a coolant outlet line that are designed to be connected fluidically to the coolant loop, the inlet line being fluidically connected at one end to one of the inlet orifices of the first inlet manifold and at the other end to the inlet of the second inlet manifold, the outlet line being fluidically connected to one of the outlet orifices of the second outlet manifold and to the outlet of the first outlet manifold, characterized in that the heat exchanger comprises at least one four-way valve that is able to adopt a first position in which the four-way valve fluidically connects one of the inlet orifices of the first inlet manifold to the inlet line and one of the outlets of the second outlet manifold to the outlet line, and at least a second position in which the four-way valve fluidically connects one of the inlet orifices of the first inlet manifold to the outlet line and one of the outlets of the second outlet manifold to the inlet line.

The coolant loop can be arranged inside a vehicle, for example an electric or hybrid vehicle, to heat or cool a passenger compartment of said vehicle, notably by means of an exchange of calories in the heat exchanger between the coolant and an outside air flow. The coolant loop can comprise a reversible heat pump and the heat exchanger can be an evaporative condenser in which the coolant circulates. More specifically, the heat exchanger comprises a heat-exchange surface in which calories are exchanged between the air flow traversing said exchange surface and the coolant circulating inside the tubes extending between the different manifolds of the heat exchanger, the coolant capturing or ceding calories with the air flow depending on the operating mode of the coolant loop, i.e. a heating mode or a cooling mode for the passenger compartment.

Furthermore, this means that a first part of the coolant circulates through the heat exchanger by circulating in the first heat-exchange circuit, and that a second part of the coolant circulates through the heat exchanger by circulating in the second heat-exchange circuit.

To do so, the first part of the coolant circulates in the first set of tubes, for example from the first inlet manifold to the first outlet manifold, the second portion of the coolant circulating in the second set of tubes, for example from the second inlet manifold to the second outlet manifold.

To improve the resistance of the exchange surface against icing, the first inlet manifold and the second outlet manifold are arranged at a first longitudinal end of the tubes, while the second inlet manifold and the first outlet manifold are installed at a second longitudinal end of the tubes opposite the first longitudinal end of said tubes. This means that the direction of circulation of the first part of coolant in the first set of tubes is opposite the direction of circulation of the second part of coolant in the second set of tubes.

According to an alternative of the invention, the first inlet manifold and the second outlet manifold form a one-piece assembly.

According to another alternative of the invention, the second inlet manifold and the first outlet manifold form a one-piece assembly.

The term “one-piece” means for example that cannot be separated from one another without destroying one or the other of the manifolds. The first manifold and the second manifold are for example two brazed tubes, or a single tube that has an internal partition.

Alternating the direction of circulation of the coolant between two successive tubes optimizes the resistance of the exchange surface against icing. Opposing the direction of circulation of the coolant in two neighboring tubes is a smart solution for limiting the appearance of ice on and between the tubes of the heat exchanger.

Furthermore, the four-way valve makes it possible to guide the fluid along a first coolant circulation path or a second coolant circulation path through the first and second heat-exchange circuits. In each of the coolant circulation paths, the coolant circulates in a first direction of circulation in one tube, and in an opposite direction of circulation in at least one of the neighboring tubes.

According to an optional feature of the invention, at least the first inlet manifold comprises a separating wall participating in defining a first collector chamber and a second collector chamber, at least a first inlet orifice feeding the first collector chamber and at least a second inlet orifice feeding the second collector chamber.

The first collector chamber is fluidically sealed from the second collector chamber by the separating wall. This means that the separating wall between the first collector chamber and the second chamber prevents coolant from circulating directly between the two collector chambers. The coolant thus passes through at least one tube to circulate from one collector chamber to the other.

Furthermore, each of the collector chambers is fed by a coolant inlet orifice, i.e. for example the coolant enters one of the collector chambers through the inlet orifice connected to said chamber before circulating through the chamber and then to at least one of the tubes of the first heat-exchange circuit.

According to another optional feature of the invention, at least the second outlet manifold comprises a separating wall participating in defining a first collector cavity and a second collector cavity, the first collector cavity opening into a first outlet and the second collector cavity opening into a second outlet.

The first collector cavity is fluidically sealed from the second collector cavity by the separating wall. This means that the separating wall between the first collector cavity and the second cavity prevents coolant from circulating directly between the two collector cavities. The coolant thus passes through at least one tube to circulate from one collector cavity to the other.

Furthermore, each of the collector cavities has a coolant outlet, i.e. for example the coolant enters one of the collector cavities through at least one of the tubes of the second heat-exchange circuit connected to said cavity before circulating through the cavity and then leaving this cavity through the coolant outlet connected to said cavity.

According to another optional feature of the invention, the inlet line is fluidically connected to the first inlet orifice, to the second inlet orifice of the first inlet manifold and to the inlet of the second inlet manifold when the four-way valve is in the first position, the outlet line being fluidically connected to the outlet orifice of the first outlet manifold, to the first outlet and to the second outlet of the second outlet manifold.

According to another optional feature of the invention, the inlet line is fluidically connected to the first inlet orifice of the first inlet manifold and to the second outlet of the second outlet manifold when the four-way valve is in the second position, the outlet line being fluidically connected to the second inlet orifice of the first inlet manifold and to the first outlet of the second outlet manifold.

According to another optional feature of the invention, the outlet line comprises at least a first conduit that is connected to the outlet orifice of the first outlet manifold and on which a valve is installed, the valve being able to adopt a first position enabling coolant to circulate in the first conduit and a second position preventing coolant from circulating in the first conduit.

This means that the valve, when it is in the first position, enables the coolant to be discharged from the outlet orifice of the first outlet manifold directly to the outlet line through the first conduit.

Conversely, when the valve is in the second position, the valve blocks circulation of the coolant directly to the outlet line through the first conduit, forcing the coolant to circulate to the second collector chamber and to the second inlet orifice.

Advantageously, the valve is switched uniquely to the first position or the second position. In other words, the valve can either enable or block circulation of the coolant through the first conduit.

According to another optional feature of the invention, the outlet line comprises a second conduit fluidically connected to the first outlet of the second outlet manifold. The second conduit is separate from the first conduit.

According to another optional feature of the invention, the outlet line comprises a third conduit connected to the four-way valve, the four-way valve fluidically connecting the third conduit to the second outlet of the second outlet manifold when the four-way valve is in the first position, the four-way valve fluidically connecting the third conduit to the second inlet orifice of the first inlet manifold when the four-way valve is in the second position.

According to another optional feature of the invention, the inlet line comprises at least a first channel connected to the inlet of the second inlet manifold and on which a valve is installed, the valve being able to adopt a first position enabling coolant to circulate in the first channel and a second position preventing coolant from circulating in the first channel.

This means that when the valve is in the first position, it enables coolant to be fed to the second inlet manifold directly from the inlet line, the coolant circulating through the first channel.

Conversely, when the valve is in the second position, the valve blocks circulation of the coolant directly to the coolant inlet of the second inlet manifold from the inlet line through the first channel, the coolant then feeding the second heat-exchange circuit by passing through the second coolant outlet of the second collector cavity of the second outlet manifold.

Advantageously, the valve is switched uniquely to the first position or the second position. In other words, the valve can either enable or block circulation of the coolant through the first channel.

According to another optional feature of the invention, the inlet line comprises a second channel fluidically connected to the first inlet orifice of the first inlet manifold. The second channel is separate from the first channel.

According to another optional feature of the invention, the inlet line comprises a third channel connected to the four-way valve, the four-way valve fluidically connecting the third channel to the second inlet orifice of the first inlet manifold when the four-way valve is in the first position, the four-way valve fluidically connecting the third channel to the second outlet of the second outlet manifold when the four-way valve is in the second position.

According to another optional feature of the invention, the four-way valve and the two valves are each in their first position to enable the heat exchanger according to the invention to be used in a coolant evaporation mode.

“First position” means that the four-way valve and the two valves cooperate to guide the coolant through the heat exchanger being used in a coolant evaporation mode. The four-way valve and the two valves are in the first position notably when the coolant loop is used to heat an air flow sent to the passenger compartment of the vehicle.

Furthermore, in the coolant evaporation mode, the coolant captures calories by circulating through the tubes, the calories being ceded by an air flow circulating through the heat-exchange surface, i.e. about and between the tubes. The coolant reaching the inlet line in a liquid or two-phase state changes state from a liquid state to a gas state as a result of the increase in the temperature thereof caused by the capture of calories by passing through the tubes.

According to another optional feature of the invention, the four-way valve and the two valves are each in their second position to enable the heat exchanger according to the invention to be used in a coolant condensation mode.

“Second position” means that the four-way valve and the two valves cooperate to guide the coolant through the heat exchanger being used in a coolant condensation mode. The four-way valve and the two valves are in the second position notably when the coolant loop is used to cool an air flow sent to the passenger compartment of the vehicle.

Furthermore, in the coolant condensation mode, the coolant, by circulating through the tubes, cedes calories to the air flow circulating through the heat-exchange surface, i.e. about and between the tubes. The coolant then reaching the inlet line in a gas state changes state from a gas state to a liquid state as a result of the decrease in the temperature thereof caused by the ceding of calories, by passing through the tubes.

According to another optional feature of the invention, the first circuit and the second circuit are I-shaped when viewed in a main plane of extension of the heat-exchange surface when the four-way valve and the two valves are in their first position.

“I-shaped circuits” means that the coolant circulates in a single direction of circulation that is parallel to the main axis of elongation of the tubes, from the first inlet manifold to the second outlet manifold for the first heat-exchange circuit and from the second inlet manifold to the second outlet manifold for the second heat-exchange circuit.

Therefore, when the four-way valve and the two valves are each in the first position, the inlet line feeds coolant, in the first heat-exchange circuit, to the first collector chamber and the second collector chamber by passing respectively through the first inlet orifice and the second inlet orifice, then the coolant circulates to the first outlet manifold through the first set of tubes, the coolant being finally discharged through the outlet orifice of the first outlet manifold to the outlet line.

Similarly, in the second heat-exchange circuit, when the four-way valve and the two valves are each in the first position, the inlet line feeds coolant to the second inlet manifold, the coolant passing through the coolant inlet to feed the second inlet manifold, the coolant then circulating to each of the collector cavities of the second outlet manifold, the coolant finally being discharged through each of the outlets of the second outlet manifold to the outlet line.

According to another optional feature of the invention, the first circuit and the second circuit are U-shaped when viewed in a main plane of extension of the heat-exchange surface when the four-way valve and the two valves are in their second position.

“U-shaped circuits” means that the coolant circulates in a first direction of circulation and in a second direction of circulation inside the heat-exchange surface, each of these directions of circulation being parallel to the main axis of elongation of the tubes, the coolant passing from one manifold to the other in the first direction of circulation, then returning to the first manifold in the second direction of circulation.

Therefore, when the four-way valve and the two valves are each in the second position, the inlet line feeds coolant, in the first heat-exchange circuit, to the first collector chamber only by passing through the first inlet orifice, the coolant then circulating to the first outlet manifold through a subset of the first set of tubes, the coolant then circulating from the first outlet manifold to the second collector chamber through another subset of the first set of tubes to finally be discharged to the outlet line through the second inlet orifice. The valve switched to the second position blocks the circulation of the coolant to the outlet line and forces the coolant to circulate from the first outlet manifold to the second collector chamber of the first inlet manifold.

Similarly, when the four-way valve and the two valves are each in the second position, the inlet line feeds coolant, in the second heat-exchange circuit, to the second collector cavity only by passing through the second coolant outlet, the coolant then circulating to the second inlet manifold through a subset of the second set of tubes, the coolant then circulating from the second inlet manifold to the first collector cavity through another subset of the second set of tubes to finally be discharged to the outlet line through the first coolant outlet. The valve switched to the second position blocks circulation of the coolant from the inlet line to the coolant inlet of the second inlet manifold and forces the coolant to circulate from the second inlet manifold to the first collector cavity of the second outlet manifold.

The present invention also relates to a coolant loop of a vehicle comprising at least a compression member, a heat exchanger as described in the present document, a first expansion member and a second expansion member, a first heat exchanger and a network of pipes connecting these components of the coolant loop together.

According to another optional feature of the invention, the inlet line of the heat exchanger is connected to the second expansion member.

According to another optional feature of the invention, the coolant loop comprises at least a coolant accumulation device and a second heat exchanger.

According to another optional feature of the invention, the coolant loop comprises at least one regulating member for the coolant, the regulating member being able to adopt a first position directly fluidically connecting the first heat exchanger to the outlet line and a second position blocking the circulation of the coolant through a portion of the outlet line.

The present invention finally relates to a method for controlling a coolant loop according to one of the preceding features, said method comprising heating a passenger compartment of the vehicle during which the four-way valve and the two valves are each switched to the first position and cooling the passenger compartment of the vehicle during which the four-way valve and the two valves are each switched to the second position.

### BRIEF DESCRIPTION OF DRAWINGS

Other features, details and advantages of the invention are set out more clearly in the description below as well as in several example embodiments provided by way of non-limiting examples with reference to the schematic drawings attached, in which:

FIG. 1 is a perspective view of a heat exchanger according to the invention,

FIG. 2 is a schematic representation of the heat exchanger shown in FIG. 1, in which a four-way valve is switched to a first position,

FIG. 3 is a schematic representation of the heat exchanger shown in FIG. 1, in which a four-way valve is switched to a second position,

FIG. 4 is a schematic representation of a coolant loop comprising the heat exchanger shown in FIG. 1, and in which a four-way valve of the heat exchanger is switched to a first position,

FIG. 5 is a schematic representation of a coolant loop comprising the heat exchanger shown in FIG. 1, and in which a four-way valve of the heat exchanger is switched to a second position, and

FIG. 6 is a schematic representation of a method according to the invention.

### DETAILED DESCRIPTION OF THE INVENTION

The features, variants and different embodiments of the invention can be associated with one another in different combinations, where not incompatible with one another or mutually exclusive. Notably, variants of the invention that only include a selection of features described below separately from the other described features are also possible, where this selection of features is sufficient to provide a technical advantage and/or to differentiate the invention from the prior art.

In the figures, elements common to several figures have the same reference sign.

Furthermore, the terms “upstream” and “downstream” used hereinafter in the description refer to the direction of circulation of a coolant through the heat exchanger and the coolant loop.

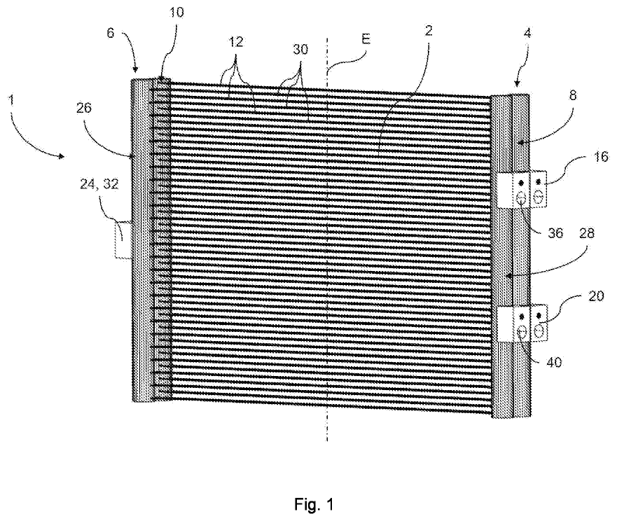

FIG. 1 shows a heat exchanger 1 according to the invention that can be traversed on the outside by an air flow and by a coolant circulating on the inside of this heat exchanger 1, the latter being designed to be built into a coolant loop installed on an electric and/or hybrid vehicle. More specifically, inside the heat exchanger 1, the coolant is thermally treated so as to be heated or cooled, then driven in circulation through the coolant loop.

As shown in FIG. 1, the heat exchanger 1 according to the invention comprises a heat-exchange surface 2 that extends in a main plane of extension and that is intended to be traversed by an air flow coming from outside a passenger compartment of a vehicle. The heat exchange between the coolant and the air flow occurs at the heat-exchange surface 2 of the heat exchanger 1.

According to the invention, the heat exchanger 1 also comprises at least a first heat-exchange circuit 4 and a second heat-exchange circuit 6 through which the coolant circulates. These two heat-exchange circuits at least partially participate in delimiting the heat-exchange surface 2.

As shown in FIG. 1, the first heat-exchange circuit 4 comprises a first coolant inlet manifold 8, a first coolant outlet manifold 10, and at least a first set of tubes 12 extending longitudinally between the first inlet manifold 8 and the first outlet manifold 10. In other words, the tubes 12 of the first heat-exchange circuit 4 extend in a main direction of elongation between the first inlet manifold 8 and the first outlet manifold 10. Furthermore, the first set of tubes 12 fluidically connects the first inlet manifold 8 to the first outlet manifold 10, i.e. a fluid circulating in the first inlet manifold 8 can circulate as far as the first outlet manifold 10 through the first set of tubes 12.

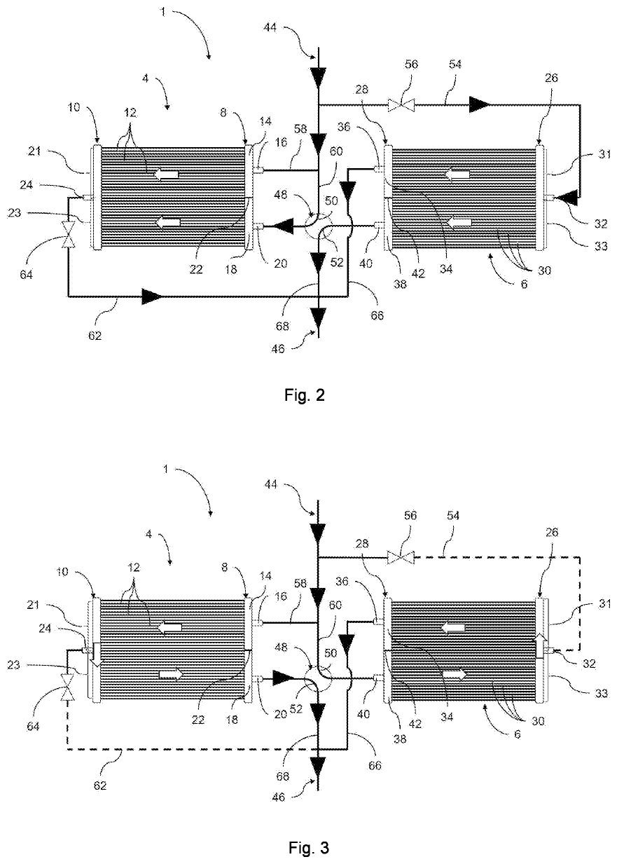

According to the invention and as more specifically shown in FIGS. 2 and 3, the first inlet manifold 8 contains at least two collector chambers 14, 18, each of which is fed by at least one inlet orifice 16, 20. More specifically, the first inlet manifold 8 comprises a first collector chamber 14 fed with coolant through a first coolant inlet orifice 16 and a second collector chamber 18 fed with coolant through a second coolant inlet orifice 20.

Furthermore, FIGS. 2 and 3 each show at least the first heat-exchange circuit 4 and the second heat-exchange circuit 6 illustrated separately to facilitate comprehension. However, these heat-exchange circuits 4, 6 are nested together to form a component that is the heat exchanger 1 according to the invention.

The first inlet manifold 8 comprises a separating wall 22 that participates in delimiting the first collector chamber 14 and the second collector chamber 18. Advantageously, the separating wall 22 delimits the two collector chambers 14, 18 such that they have the same volume.

The first collector chamber 14 is fluidically sealed from the second collector chamber 18 by the separating wall 22. This means that the separating wall 22 between the first collector chamber 14 and the second collector chamber 18 prevents coolant from circulating directly between the two collector chambers 14, 18.

Each of the collector chambers 14, 18 is connected to the first outlet manifold 10 by the first set of tubes 12. More specifically, the first inlet orifice 16 and the first collector chamber 14 are fluidically connected to the first outlet manifold 10 by a subset 21 of the first set of tubes 12, while the second inlet orifice 20 and the second collector chamber 18 are fluidically connected to the first outlet manifold 10 by another subset 23 of the first set of tubes 12.

The first outlet manifold 10 comprises at least one outlet orifice 24 fluidically connecting the first outlet manifold 10 to a conduit, for example.

Similarly, the second heat-exchange circuit 6 further comprises a second coolant inlet manifold 26, a second coolant outlet manifold 28, and at least a second set of tubes 30 extending longitudinally between the second inlet manifold 26 and the second outlet manifold 28. In other words, the tubes 30 of the second heat-exchange circuit 6 extend in the main direction of elongation between the second inlet manifold 26 and the second outlet manifold 28. Furthermore, the second set of tubes 30 fluidically connects the second inlet manifold 26 to the second outlet manifold 28, i.e. a fluid circulating in the second inlet manifold 26 can circulate as far as the second outlet manifold 28 through the second set of tubes 30.

The second inlet manifold 26 comprises at least one coolant inlet 32 fluidically connecting the second inlet manifold 26 to a channel, for example.

The second outlet manifold 28 participates in delimiting at least two collector cavities 34, 38, each opening into at least one coolant outlet 36, 40. More specifically, the second outlet manifold 28 comprises a first collector cavity 34 opening into a first coolant outlet 36 and a second collector cavity 38 opening into a second coolant outlet 40.

The second outlet manifold 28 comprises another separating wall 42 that participates in delimiting the first collector cavity 34 and the second collector cavity 38. Advantageously, the separating wall 22 delimits the two collector cavities such that they have the same volume.

The first collector cavity 34 is fluidically sealed from the second collector cavity 38 by the separating wall 42. This means that the separating wall 42 between the first collector cavity 34 and the second collector cavity 38 prevents coolant from circulating directly between the two collector cavities 34, 38.

Each of the collector cavities 34, 38 is connected to the second inlet manifold 26 by the second set of tubes 30. More specifically, the second inlet manifold 26 is fluidically connected to the first collector cavity 34 and to the first outlet 36 by a subset 31 of the second set of tubes 30, the second inlet manifold 26 being fluidically connected to the second collector cavity 38 and to the second outlet 40 by another subset 33 of the second set of tubes 30.

According to the invention and as shown in FIGS. 1 to 3, the tubes of the first set of tubes 12 are stacked alternately with the tubes of the second set of tubes 30 in a stacking direction E inscribed in a plane of extension of the heat-exchange surface 2 and perpendicular to a main direction of elongation of at least one of the tubes 12, 30. In other words, at least one of the tubes of the first set of tubes 12 is surrounded on both sides in the stacking direction E by two tubes of the second set of tubes 30, and at least one of the tubes of the second set of tubes 30 is surrounded on both sides in the stacking direction E by two tubes of the first set of tubes 12.

Furthermore, the first inlet manifold 8 and the second outlet manifold 28 are arranged at a first longitudinal end of the tubes 12, 30, the second inlet manifold 26 and the first outlet manifold 10 being installed at a second longitudinal end of the tubes 12, 30. In other words, the first inlet manifold 8 and the second outlet manifold 28 are arranged opposite the second inlet manifold 26 and the second outlet manifold 28 in relation to the tubes 12, 30.

According to an alternative of the invention, the first inlet manifold 8 and the second outlet manifold 28 form a one-piece assembly. In other words, the first inlet manifold 8 and the second outlet manifold 28 are associated at the time of manufacture so that removing one of the manifolds 8, 28 would at least partially destroy one or the other of the manifolds 8, 28.

According to another alternative of the invention, the second inlet manifold 26 and the first outlet manifold 10 form a one-piece assembly. In other words, the second inlet manifold 26 and the first outlet manifold 10 are associated at the time of manufacture so that removing one of the manifolds 10, 26 would at least partially destroy one or the other of the manifolds 10, 26.

As is particularly visible in FIGS. 2 and 3, the heat exchanger 1 comprises a coolant inlet line 44 and a coolant outlet line 46 that are designed to be connected fluidically to the coolant loop. The inlet line 44 is at least fluidically connected at one end to one of the inlet orifices 16, 20 of the first inlet manifold 8 and at the other end to the inlet 32 of the second inlet manifold 26. The outlet line 46 is at least fluidically connected to the outlet orifice 24 of the first outlet manifold 10 and to one of the outlets 36, 40 of the second outlet manifold 28.

According to the invention, the heat exchanger 1 comprises at least one four-way valve 48 that is able to adopt a first position in which the four-way valve 48 fluidically connects one of the inlet orifices 16, 20 of the first inlet manifold 8 to the inlet line 44 and one of the outlets 36, 40 of the second outlet manifold 28 to the outlet line 46, and at least a second position in which the four-way valve 48 fluidically connects one of the inlet orifices 16, 20 of the first inlet manifold 8 to the outlet line 46 and one of the outlets 36, 40 of the second outlet manifold 28 to the inlet line 44.

More specifically, the four-way valve 48 comprises a first pass 50 fluidically connected to the inlet line 44 regardless of the position of the four-way valve 48, and a second pass 52 fluidically connected to the outlet line 46 regardless of the position of the four-way valve 48.

Furthermore, when the four-way valve 48 is in the first position, the first pass 50 fluidically connects the inlet line 44 to the second inlet orifice 20 of the first inlet manifold 8, the second pass 52 fluidically connecting the second outlet 40 of the second outlet manifold 28 to the outlet line 46. When the four-way valve 48 is in the second position, the first pass 50 fluidically connects the inlet line 44 to the second outlet 40 of the second outlet manifold 28, the second pass 52 fluidically connecting the second inlet orifice 20 of the first inlet manifold 8 to the outlet line 46.

This means that, when the four-way valve 48 is in the first position, the inlet line 44 is fluidically connected to the first inlet orifice 16 and to the second inlet orifice 20 of the first inlet manifold 8, as well as to the inlet of the second inlet manifold 26. The outlet line 46 is fluidically connected to the outlet orifice 24 of the first outlet manifold 10 and to the first outlet 36 and to the second outlet 40 of the second outlet manifold 28.

When the four-way valve 48 is in the second position, the inlet line 44 is then fluidically connected to the first inlet orifice 16 of the first inlet manifold 8 and to the second outlet 40 of the second outlet manifold 28, while the outlet line 46 is fluidically connected to the second inlet orifice 20 of the first inlet manifold 8 and to the first outlet 36 of the second outlet manifold 28.

Furthermore, the inlet line 44 comprises at least a first channel 54 fluidically connected to the inlet 32 of the second inlet manifold 26, and on which a valve 56 is installed. According to the invention, the valve 56 can adopt a first position enabling coolant to circulate in the first channel 54 and a second position preventing coolant from circulating in the first channel 54.

This means that when the valve 56 is in the first position, it enables coolant to be fed to the second inlet manifold 26 directly from the inlet line 44, the coolant circulating through the first channel 54. Conversely, when the valve 56 is in the second position, the valve 56 blocks circulation of the coolant directly to the coolant inlet 32 of the second inlet manifold 26 from the inlet line 44 through the first channel 54.

Advantageously, the valve 56 is switched uniquely to the first position or the second position. In other words, the valve 56 can either enable or block circulation of the coolant through the first channel 54.

Furthermore, the inlet line 44 comprises a second channel 58 fluidically connected to the first inlet orifice 16 of the first inlet manifold 8 and a third channel 60 connected to the four-way valve 48. More specifically, the third channel 60 is fluidically connected to the first pass 50 of the four-way valve 48 when the latter is in the first position and also when the latter is in the second position. In other words, the third channel 60 is fluidically connected to the second inlet orifice 20 of the first inlet manifold 8 by means of the first pass 50 of the four-way valve 48 or to the second outlet 40 of the second outlet manifold 28 by means of the first pass 50 of the four-way valve 48.

Similarly, the outlet line 46 comprises at least a first conduit 62 connected to the outlet orifice 24 of the first outlet manifold 10, and on which a valve 64 is installed. The valve 64 can adopt a first position enabling coolant to circulate in the first conduit 62 and a second position preventing coolant from circulating in the first conduit 62.

This means that the valve 64, when it is in the first position, enables the coolant to be discharged from the outlet orifice 24 of the first outlet manifold 10 directly to the outlet line 46 through the first conduit 62. Conversely, when the valve 64 is in the second position, the valve 64 blocks the circulation of the coolant directly to the outlet line 46 from the outlet orifice 24 of the first outlet manifold 10 through the first conduit 62.

Advantageously, the valve 64 is switched uniquely to the first position or the second position. In other words, the valve 64 can either enable or block circulation of the coolant through the first conduit 62.

Furthermore, the outlet line 46 comprises a second conduit 66 fluidically connected to the first outlet 36 of the second outlet manifold 28 and a third conduit 68 connected to the four-way valve 48. More specifically, the third conduit 68 is fluidically connected to the first pass 50 of the four-way valve 48 when the latter is in the second position or also when the latter is in the first position. In other words, the third conduit 68 is fluidically connected to the second inlet orifice 20 of the first inlet manifold 8 by means of the second pass 52 when the four-way valve 48 is in the second position, or is fluidically connected to the second outlet 40 of the second outlet manifold 28 by means of the second pass 52 when the four-way valve 48 is in the first position.

The circulation of the coolant inside the heat exchanger 1 is described below, notably with reference to FIGS. 2 and 3.

As shown in FIGS. 2 and 3, the coolant enters the heat exchanger 1 by circulating through the inlet line 44, then through the first, second and third channels 54, 58, 60.

Depending on the position of the four-way valve 48, the valve 64 and the valve 56, the coolant circulates in the first heat-exchange circuit 4 and in the second heat-exchange circuit 6 in different ways.

As shown in FIG. 2, the four-way valve 48, the valve 64 and the valve 56 are each in their first position and define a coolant evaporation mode, i.e. the coolant passes from a liquid state to a gas state by circulating through the heat exchanger 1, by means of heat exchange with the air flow passing across the exchange surface. In the coolant evaporation mode, the coolant captures calories by circulating through the tubes 12 of the first heat-exchange circuit 4 and the tubes 30 of the second heat-exchange circuit 6, the calories being ceded by an air flow circulating in the heat-exchange surface 2, i.e. about and between the tubes 12, 30. The coolant reaching the inlet line 44 in a liquid or two-phase state can change state from a liquid state to a gas state as a result of the increase in the temperature thereof caused by the capture of calories from the air flow by passing through the tubes 12, 30.

The term “first position” of the four-way valve 48, the valve 64 and the valve 56 refers to a simultaneous cooperation therebetween to guide the coolant through the heat exchanger 1 in the coolant evaporation mode. The four-way valve 48, the valve 64 and the valve 56 are in the first position notably when the coolant loop is used to heat an air flow intended to circulate to the passenger compartment of the vehicle.

More specifically, when the four-way valve 48, the valve 64 and the valve 56 are in the first position, a first part of the coolant circulates to the first heat-exchange circuit 4, on one hand through the second channel 58 and therefore to the first inlet orifice 16 of the first inlet manifold 8, and on the other hand through the third channel 60 to the second inlet orifice 20 of the first inlet manifold 8. This means that the coolant circulates in the third channel 60 through the first pass 50 of the four-way valve 48 to circulate through the second coolant inlet orifice 20. The first part of the coolant then circulates in the first collector chamber 14 and in the second collector chamber 18 to the first outlet manifold 10 through the first set of tubes 12. The first part of coolant then circulates from the first outlet manifold 10 to the first conduit 62 of the outlet line 46 through the outlet orifice 24 of the first outlet manifold 10.

Similarly, when the four-way valve 48, the valve 64 and the valve 56 are in the first position, a second part of the coolant circulates to the second heat-exchange circuit 6 through the first channel 54 to the second inlet manifold 26. The second part of the coolant enters the second inlet manifold 26 through the fluid inlet 32, then circulates to the second outlet manifold 28 through the second set of tubes 30. More specifically, the second part of coolant circulates to the first collector cavity 34 and the second collector cavity 38 of the second outlet manifold 28. The coolant circulating in the first collector cavity 34 then circulates to the second conduit 66 of the outlet line 46 by passing through the first fluid outlet 36 of the second outlet manifold 28. The coolant circulating in the second collector cavity 38 then circulates to the third conduit 68 of the outlet line 46 by passing through the second coolant outlet 40 of the second outlet manifold 28. More specifically, the coolant circulates to the third conduit 68 of the outlet line 46 by passing through the second coolant outlet 40 then through the second pass 52 of the four-way valve 48.

According to one embodiment of the invention, the path of the coolant through the first heat-exchange circuit 4 and the second heat-exchange circuit 6 is I-shaped when viewed in a main plane of extension of the heat-exchange surface 2 when the four-way valve 48, the valve 64 and the valve 56 are in their first position. This means that the coolant circulates in a single direction of circulation in the first heat-exchange circuit 4 from the first inlet manifold 8 to the first outlet manifold 10, and also in a single direction of circulation in the second heat-exchange circuit 6 from the second inlet manifold 26 to the second outlet manifold 28.

Therefore, when the four-way valve 48, the valve 64 and the valve 56 are in the first position, the coolant circulates in the first heat-exchange circuit 4 in a first direction and in the second heat-exchange circuit 6 in a second direction opposite the first direction. The arrangement of the first set of tubes 12 in relation to the second set of tubes 30 causes the coolant to circulate in a tube in the opposite direction to the circulation of the coolant in the neighboring tubes.

As shown in FIG. 3, the four-way valve 48, the valve 64 and the valve 56 are each in their second position and define a coolant condensation mode, i.e. the coolant passes from a gas state to a liquid state. In the coolant condensation mode, the coolant, by circulating through the tubes 12, 30, cedes calories to an air flow circulating in the heat-exchange surface 2, i.e. about and between the tubes. The coolant reaching the inlet line 44 in a gas state can change state from a gas state to a liquid state as a result of the decrease in the temperature thereof caused by the ceding of calories to the air flow, by passing through the tubes.

The term “second position” of the four-way valve 48, the valve 64 and the valve 56 refers to a simultaneous cooperation therebetween to guide the coolant through the heat exchanger 1 in the coolant condensation mode. The four-way valve 48, the valve 64 and the valve 56 are in the second position notably when the coolant loop is used to cool an air flow intended to circulate to the passenger compartment of the vehicle.

More specifically, when the four-way valve 48, the valve 64 and the valve 56 are in the second position, a first part of the coolant circulates to the first heat-exchange circuit 4 exclusively through the second channel 58 to the first inlet orifice 16 of the first inlet manifold 8. This means that, unlike the evaporation mode, the first part of the coolant enters the first heat-exchange circuit 4 exclusively through the first inlet orifice 16 of the first outlet manifold 10. The coolant then circulates from the first collector chamber 14 through the subset 21 of the first set of tubes 12 to the first outlet manifold 10. The position of the valve 64 here prevents the coolant from circulating from the outlet orifice 24 of the first outlet manifold 10 to the outlet line 46 through the first conduit 62. The coolant then circulates to the first inlet manifold 8, and more specifically to the second collector chamber 18 of the first inlet manifold 8 through another subset 23 of the first set of tubes 12. The coolant circulating in the second collector chamber 18 then circulates to the third conduit 68 of the outlet line 46 passing through the second coolant inlet orifice 20 of the first inlet manifold 8. More specifically, the coolant circulates to the third conduit 68 of the outlet line 46 passing through the second coolant inlet orifice 20 then through the second pass 52 of the four-way valve 48.

When the four-way valve 48, the valve 64 and the valve 56 are in the second position, a second part of the coolant circulates to the second heat-exchange circuit 6 through the third channel 60 to the second coolant outlet 40 of the second outlet manifold 28. Indeed, the second position of the valve 56 blocks the circulation of the coolant through the first channel 54, the second part of the coolant then traversing the first pass 50 of the four-way valve 48 to circulate from the third channel 60 to the second coolant outlet 40 of the second outlet manifold 28. The second part of coolant enters the second outlet manifold 28 through the second coolant outlet 40 and through the second collector cavity 38, then circulates to the second inlet manifold 26 through a subset 33 of the second set of tubes 30. The second part of coolant then circulates to the first collector cavity 34 of the second outlet manifold 28 from the second inlet manifold 26 through another subset 31 of the second set of tubes 30. The coolant circulating in the first collector cavity 34 then circulates to the second conduit 66 of the outlet line 46 by passing through the first fluid outlet 36 of the second outlet manifold 28.

According to one embodiment of the invention, the path of the coolant through the first heat-exchange circuit 4 and the second heat-exchange circuit 6 is U-shaped when viewed in a main plane of extension of the heat-exchange surface 2 when the four-way valve 48, the valve 64 and the valve 56 are in their second position. This means that the coolant circulates in two directions of circulation in the first heat-exchange circuit 4 from the first inlet manifold 8 to the first outlet manifold 10 through the subset 21 of the first set of tubes 12, then from the first outlet manifold 10 to the first inlet manifold 8 through another subset 23 of the first set of tubes 12, and in the second heat-exchange circuit 6 from the second outlet manifold 28 to the second inlet manifold 26 through a subset 33 of the second set of tubes 30, then from the second inlet manifold 26 to the second outlet manifold 28 through another subset 31 of the second set of tubes 30.

Similarly to the foregoing, the coolant thus always circulates in a tube 12, 30 in a direction opposite at least one neighboring tube 12, 30. More specifically, a tube 12 of the first heat-exchange circuit 4 is surrounded in the stacking direction E by at least one tube 30 of the second heat-exchange circuit 6. Therefore, even when the path of the coolant through the first heat-exchange circuit 4 and the second heat-exchange circuit 6 is U-shaped, the coolant circulates in a first direction in the tube 12 of the first heat-exchange circuit 4 and in an opposite direction in the tube 30 of the second heat-exchange circuit 6 adjacent to said tube 12.

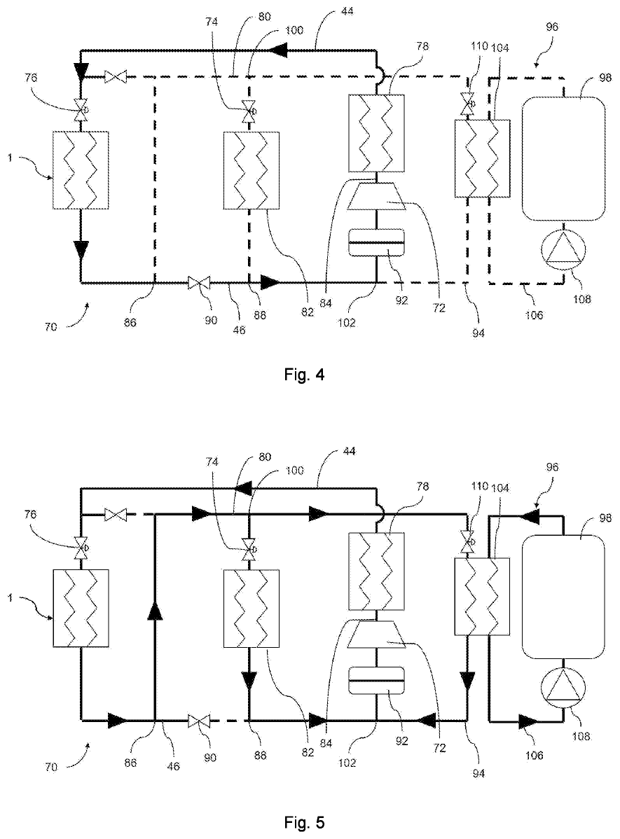

As shown in FIGS. 4 and 5, the coolant loop 70 comprises at least a coolant compression member 72, the heat exchanger 1 described above, a first expansion member 74 and a second expansion member 76, a first heat exchanger 78 between the coolant and an air flow, and a network of pipes connecting these components of the coolant loop 70 together. Advantageously, the coolant loop 70 comprises a detour line 80 and a second heat exchanger 82 installed on the detour line 80.

More specifically, the inlet line 44 of the heat exchanger 1 extends from the first heat exchanger 78 to the heat exchanger 1, the outlet line 46 of the heat exchanger 1 extending between the heat exchanger 1 and the compression member 72, the compression member 72 being fluidically connected to the first heat exchanger 78 by a pipe 84. The coolant loop 70 forms a closed circuit in which the coolant circulates, for example, in the outlet line 46 from the heat exchanger 1 to the compression member 72, then through the pipe 84 from the compression member 72 to the first heat exchanger 78, and finally in the inlet line 44 from the first heat exchanger 78 to the heat exchanger 1.

As described above, the heat exchanger 1 carries out a heat exchange between the coolant and a first air flow coming from outside the passenger compartment of the vehicle.

The first heat exchanger 78 and the second heat exchanger 82 are configured to exchange heat between the coolant and a second air flow intended to circulate to the passenger compartment of the vehicle, referred to as the interior air flow. In this configuration, the coolant circulating through each of these heat exchangers exchanges calories to heat or cool the second air flow.

The compression member 72 is configured to increase the pressure of the coolant. This means that a pressure of the coolant in the outlet line 46 is lower than a pressure of the coolant circulating in the pipe 84 between the compression member 72 and the first heat exchanger 78.

The detour line 80 comprises a first intersection 86 with the outlet line 46 and a second intersection 88 with the outlet line 46, the detour line 80 extending between these two intersections 86, 88. The coolant circulating in the outlet line 46 can circulate directly from the heat exchanger 1 to the compression member 72, or circulate through the detour line 80 to traverse the second heat exchanger 82.

Preferably, the coolant loop 70 comprises at least one regulating member 90 for regulating the circulation of the coolant that is able to adopt a first position directly fluidically connecting the first heat exchanger 78 to the outlet line 46 and a second position blocking the circulation of the coolant through a portion of the outlet line 46. The change of position of the regulating member 90 is in this case correlated with the change of positions of the four-way valve 48, the valve 64 and the valve 56. When the regulating member 90 is in the first position, the coolant circulates through the outlet line 46 directly to the compression member 72, whereas it circulates through the detour line 80 when the regulating member 90 is in the second position.

Advantageously, the first expansion member 74 is installed on the detour line 80, between the second heat exchanger 82 and the heat exchanger 1. The first expansion member 74 is configured to lower the pressure of the coolant when the heat exchanger 1 is in condenser mode. This means that a pressure of the coolant in the detour line 80 between the first expansion member 74 and the second heat exchanger 82 is lower than a pressure of the coolant circulating between the heat exchanger 1 and the first expansion member 74.

Similarly, the second expansion member 76 is installed on the inlet line 44 between the first heat exchanger 78 and the heat-exchange circuits 4, 6 of the heat exchanger 1 and is also configured to lower the pressure of the coolant when the heat exchanger 1 is in evaporator mode. This means that a pressure of the coolant in the inlet line 44 between the first heat exchanger 78 and the second expansion member 76 is lower than a pressure of the coolant circulating between the second expansion member 76 and the heat exchanger 1.

Furthermore, the coolant loop 70 comprises at least one coolant accumulation device 92 installed on the outlet line 46 between the compression member 72 and the heat exchanger 1. Advantageously, the accumulation device 92 is arranged between the second intersection 88 and the compression member 72. The accumulation device 92 is configured to contain a fluctuating volume of coolant, making it possible to absorb variations in the volume occupied by the coolant in the coolant loop 70, this volume varying as a result of pressure and temperature variations.

The coolant loop 70 also comprises a thermal management line 94 of a thermal management system 96 of an electric and/or electronic element 98 of the vehicle, the thermal management line 94 extending from the detour line 80 to the outlet line 46. More specifically, the coolant loop 70 comprises a first fork 100 between the thermal management line 94 and the detour line 80 and a second fork 102 between the thermal management line 94 and the outlet line 46, the first fork 100 being arranged between the first intersection 86 and the first expansion member 74, the second fork 102 being arranged between the second intersection 88 and the accumulation device 92.

The coolant loop 70 comprises a heat-exchange member 104 between the coolant circulating in the thermal management line 94 and a heat-transfer fluid circulating through the thermal management system 96. This latter further comprises a heat-transfer fluid line 106 and at least one pumping member 108 forcing the circulation of the heat-transfer fluid through the heat-transfer fluid line 106. The coolant circulating in the thermal management line 94 through the heat-exchange member 104 exchanges calories with the heat-transfer fluid of the thermal management system 96 in order to heat and/or cool the electric and/or electronic element 98 of the vehicle.

Furthermore, the coolant loop 70 can comprise a third expansion member 110 arranged on the thermal management line 94 between the first fork 100 and the heat-exchange member 104, which is intended to expand the coolant upstream of the heat-exchange member 104, notably when the heat exchanger 1 is in condenser mode.

The circulation of the coolant through the coolant loop 70 is described below with reference to FIGS. 4 and 5.

The coolant loop 70 performs a heating function for the air flow sent into the passenger compartment, as illustrated in FIG. 4. The coolant loop 70 also performs a cooling function for the air flow sent into the passenger compartment, as illustrated in FIG. 5.

As shown in FIG. 4, the four-way valve 48, the valve 64, the valve 56 and the regulating member 90 are in their first position so as to guide the coolant through a heating circuit for the air flow sent into the passenger compartment, i.e. respectively through the heat exchanger 1, the outlet line 46, the accumulation device 92, the compression member 72, the first heat exchanger 78, the inlet line 44, the second expansion member 76 and finally through the heat exchanger 1. In this configuration, the compression member 72 increases the pressure of the coolant, thereby increasing the temperature thereof, then the coolant circulates through the first heat exchanger 78, where it is condensed. The coolant is heated by the compression member 72 and then cedes calories to the air flow sent to the passenger compartment circulating through the first heat exchanger 78. The coolant then circulates through the inlet line 44 to the expansion member 76, thereby lowering the pressure of the coolant. The latter then circulates through the heat exchanger 1, which is then operating in evaporator mode, then returns to the compression member 72.

Conversely and as shown in FIG. 5, the four-way valve 48, the valve 64, the valve 56 and the regulating member 90 are in their second position so as to guide the coolant through a cooling circuit for the air flow sent into the passenger compartment, i.e. respectively through the heat exchanger 1, the outlet line 46, the detour line 80, the first expansion member 74, the second heat exchanger 82, the accumulation device 92, the compression member 72, the first heat exchanger 78, the inlet line 44, the second expansion member 76, and finally the heat exchanger 1. In this configuration, the coolant is cooled in the heat exchanger 1, which is operating in condenser mode, then expanded in the first expansion member 74. The coolant then flows through the second heat exchanger 82 to cool the second air flow.

A part of the coolant circulates through the thermal management line 94 so as to thermally treat the heat-transfer fluid of the thermal management system 96.

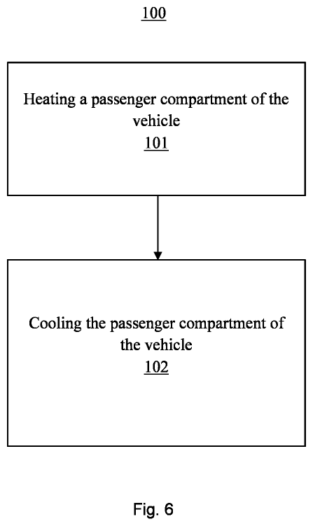

In accordance with the foregoing, and as shown in FIG. 6, the present invention finally relates to a method 100 for controlling the coolant loop 70, the method 100 comprising heating 101 a passenger compartment of the vehicle during which the four-way valve 48, the valve 64 and the valve 56 are each switched to the first position, and cooling 102 the passenger compartment of the vehicle during which the four-way valve 48, the valve 64 and the valve 56 are each switched to the second position. Furthermore, the regulating member 90 is switched to the first position during the heating 101 and to the second position during the cooling 102.

The present invention is not however limited to the means and configurations described and illustrated in the present document, and also extends to all equivalent means and configurations and to any technically operational combination of such means.

What is claimed is:

1. A heat exchanger for a coolant loop, comprising a heat-exchange surface, a first heat-exchange circuit including a first inlet manifold and a first outlet manifold between which a first set of tubes extends longitudinally, the first inlet manifold participating in delimiting at least two inlet collector chambers, each of which is fed through at least one respective inlet orifice, the first outlet manifold including at least one outlet orifice, the heat exchanger further comprising a second heat-exchange circuit including a second inlet manifold and a second outlet manifold between which a second set of tubes extends longitudinally, the second inlet manifold including at least one inlet, the second outlet manifold participating in delimiting at least two outlet collector chambers, each opening into at least one respective outlet orifice, the tubes of the first set of tubes being stacked alternately with the tubes of the second set of tubes, the heat exchanger further comprising a coolant inlet line and a coolant outlet line that are designed to be connected fluidically to the coolant loop, the inlet line being fluidically connected at one end to the at least one inlet orifices of the first inlet manifold and at the other end to the at least one inlet of the second inlet manifold, the outlet line being fluidically connected to one of the outlet orifices of the second outlet manifold and to the outlet of the first outlet manifold, wherein the heat exchanger further comprises at least one four-way valve that is able to adopt a first position in which the four-way valve fluidically connects one of the inlet orifices of the first inlet manifold to the inlet line and one of the outlet orifices of the second outlet manifold to the outlet line, and at least a second position in which the four-way valve fluidically connects one of the inlet orifices of the first inlet manifold to the outlet line and one of the outlet orifices of the second outlet manifold to the inlet line.

2. The heat exchanger as claimed in claim 1, in which at least the first inlet manifold includes a separating wall participating in defining a first collector chamber and a second collector chamber of the at least two inlet collector chambers, with the respective inlet orifices including a first inlet orifice and a second inlet orifice, the first inlet orifice feeding the first inlet collector chamber and the second inlet orifice feeding the second inlet collector chamber.

3. The heat exchanger as claimed in claim 1, wherein at least the second outlet manifold includes a separating wall participating in defining a first collector chamber and a second collector chamber of the at least two outlet collector chambers, the first outlet collector chamber opening into a first outlet orifice of the second outlet manifold and the second outlet collector chamber opening into a second outlet orifice.

4. The heat exchanger as claimed in claim 3, in which at least the first inlet manifold includes a separating wall participating in defining a first collector chamber and a second collector chamber of the at least two inlet collector chambers, with the respective inlet orifices including a first inlet orifice and a second inlet orifice, the first inlet orifice feeding the first inlet collector chamber and the second inlet orifice feeding the second inlet collector chamber, and in which the inlet line is fluidically connected to the first inlet orifice of the first inlet manifold, to the second inlet orifice of the first inlet manifold and to the at least one inlet of the second inlet manifold when the four-way valve is in the first position, the outlet line being fluidically connected to the at least one outlet orifice of the first outlet manifold, to the first outlet orifice of the second outlet manifold and to the second outlet orifice of the second outlet manifold.

5. The heat exchanger as claimed in claim 3, in which at least the first inlet manifold includes a separating wall participating in defining a first collector chamber and a second collector chamber of the at least two inlet collector chambers, with the respective inlet orifices including a first inlet orifice and a second inlet orifice, the first inlet orifice feeding the first inlet collector chamber and the second inlet orifice feeding the second inlet collector chamber, and in which the inlet line is fluidically connected to the first inlet orifice of the first inlet manifold and to the second outlet orifice of the second outlet manifold when the four-way valve is in the second position, the outlet line being fluidically connected to the second inlet orifice of the first inlet manifold and to the first outlet orifice of the second outlet manifold.

6. The heat exchanger as claimed in claim 1, in which the outlet line includes at least a first conduit that is connected to the at least one outlet orifice of the first outlet manifold and on which a first valve is installed, the first valve being able to adopt a first position enabling coolant to circulate in the first conduit and a second position preventing coolant from circulating in the first conduit.

7. The heat exchanger as claimed in claim 3, in which the outlet line includes a second conduit fluidically connected to the first outlet orifice of the second outlet manifold.

8. The heat exchanger as claimed in claim 3, in which the outlet line includes a third conduit connected to the four-way valve, the four-way valve fluidically connecting the third conduit to the second outlet orifice of the second outlet manifold when the four-way valve is in the first position, the four-way valve fluidically connecting the third conduit to the second inlet orifice of the first inlet manifold when the four-way valve is in the second position.

9. The heat exchanger as claimed in claim 1, in which the inlet line includes at least a first channel connected to the inlet of the second inlet manifold and on which a second valve is installed, the second valve being able to adopt a first position enabling coolant to circulate in the first channel and a second position preventing coolant from circulating in the first channel.

10. The heat exchanger as claimed in claim 2, in which the inlet line includes a second channel fluidically connected to the first inlet orifice of the first inlet manifold.

11. The heat exchanger as claimed in claim 3, in which at least the first inlet manifold includes a separating wall participating in defining a first collector chamber and a second collector chamber of the at least two inlet collector chambers, with the respective inlet orifices including a first inlet orifice and a second inlet orifice, the first inlet orifice feeding the first inlet collector chamber and the second inlet orifice feeding the second inlet collector chamber, and in which the inlet line includes a third channel connected to the four-way valve, the four-way valve fluidically connecting the third channel to the second inlet orifice of the first inlet manifold when the four-way valve is in the first position, the four-way valve fluidically connecting the third channel to the second outlet orifice of the second outlet manifold when the four-way valve is in the second position.

12. The heat exchanger as claimed in claim 9, in which the outlet line includes at least a first conduit that is connected to the at least one outlet orifice of the first outlet manifold and on which a first valve is installed, the first valve being able to adopt a first position enabling coolant to circulate in the first conduit and a second position preventing coolant from circulating in the first conduit, and in which the four-way valve, the first valve and the second valve are each in their first position to define a coolant evaporation mode.

13. The heat exchanger as claimed in claim 9, in which the outlet line includes at least a first conduit that is connected to the at least one outlet orifice of the first outlet manifold and on which a first valve is installed, the first valve being able to adopt a first position enabling coolant to circulate in the first conduit and a second position preventing coolant from circulating in the first conduit, and in which the four-way valve, the first valve and the second valve are each in their second position to define a coolant condensation mode.

14. The heat exchanger as claimed in claim 9, in which the outlet line includes at least a first conduit that is connected to the at least one outlet orifice of the first outlet manifold and on which a first valve is installed, the first valve being able to adopt a first position enabling coolant to circulate in the first conduit and a second position preventing coolant from circulating in the first conduit, and in which the first heat-exchange circuit and the second heat-exchange circuit are I-shaped when viewed in a main plane of extension of the heat-exchange surface when the four-way valve, the first valve and the second valve are in their first position.

15. The heat exchanger as claimed in claim 9, in which the outlet line includes at least a first conduit that is connected to the at least one outlet orifice of the first outlet manifold and on which a first valve is installed, the first valve being able to adopt a first position enabling coolant to circulate in the first conduit and a second position preventing coolant from circulating in the first conduit, and in which the first heat-exchange circuit and the second heat-exchange circuit are U-shaped when viewed in a main plane of extension of the heat-exchange surface when the four-way valve, the first valve and the second valve are in their second position.

16. A coolant loop of a vehicle comprising at least a compression member, a heat exchanger including a heat-exchange surface, a first heat-exchange circuit including a first inlet manifold and a first outlet manifold between which a first set of tubes extends longitudinally, the first inlet manifold participating in delimiting at least two inlet collector chambers, each of which is fed through at least one respective inlet orifice, the first outlet manifold including at least one outlet orifice, the heat exchanger including a second heat-exchange circuit including a second inlet manifold and a second outlet manifold between which a second set of tubes extends longitudinally, the second inlet manifold including at least one inlet, the second outlet manifold participating in delimiting at least two outlet collector chambers, each opening into at least one respective outlet orifice, the tubes of the first set of tubes being stacked alternately with the tubes of the second set of tubes, the heat exchanger including a coolant inlet line and a coolant outlet line that are designed to be connected fluidically to the coolant loop, the inlet line being fluidically connected at one end to the at least one inlet orifice of the first inlet manifold and at the other end to the at least one inlet of the second inlet manifold, the outlet line being fluidically connected to one of the outlet orifices of the second outlet manifold and to the outlet of the first outlet manifold, wherein the heat exchanger includes at least one four-way valve that is able to adopt a first position in which the four-way valve fluidically connects one of the inlet orifices of the first inlet manifold to the inlet line and one of the outlet orifices of the second outlet manifold to the outlet line, and at least a second position in which the four-way valve fluidically connects one of the inlet orifices of the first inlet manifold to the outlet line and one of the outlet orifices of the second outlet manifold to the inlet line, the coolant loop further comprising a first expansion member and a second expansion member, a first heat exchanger and a network of pipes connecting these components of the coolant loop together.

17. A method for controlling a coolant loop of a vehicle, the coolant loop including at least a compression member, a heat exchanger including a heat-exchange surface with a first heat-exchange circuit including a first inlet manifold and a first outlet manifold between which a first set of tubes extends longitudinally, the first inlet manifold participating in delimiting at least two inlet collector chambers, each of which is fed through at least one respective inlet orifice, the first outlet manifold including at least one outlet orifice, the heat exchanger including a second heat-exchange circuit including a second inlet manifold and a second outlet manifold between which a second set of tubes extends longitudinally, the second inlet manifold including at least one inlet, the second outlet manifold participating in delimiting at least two outlet collector chambers, each opening into at least one respective outlet orifice, the tubes of the first set of tubes being stacked alternately with the tubes of the second set of tubes, the heat exchanger including a coolant inlet line and a coolant outlet line that are designed to be connected fluidically to the coolant loop, the inlet line being fluidically connected at one end to the at least one inlet orifice of the first inlet manifold and at the other end to the at least one inlet of the second inlet manifold, the outlet line being fluidically connected to one of the outlet orifices of the second outlet manifold and to the outlet of the first outlet manifold, wherein the heat exchanger includes at least one four-way valve that is able to adopt a first position in which the four-way valve fluidically connects one of the inlet orifices of the first inlet manifold to the inlet line and one of the outlet orifices of the second outlet manifold to the outlet line, and at least a second position in which the four-way valve fluidically connects one of the inlet orifices of the first inlet manifold to the outlet line and one of the outlet orifices of the second outlet manifold to the inlet line, the coolant loop further comprising a first expansion member and a second expansion member, a first heat exchanger and a network of pipes connecting these components of the coolant loop together, wherein the outlet line includes at least a first conduit that is connected to the at least one outlet orifice of the first outlet manifold and on which a first valve is installed, the first valve being able to adopt a first position enabling coolant to circulate in the first conduit and a second position preventing coolant from circulating in the first conduit, wherein the inlet line includes at least a first channel connected to the inlet of the second inlet manifold and on which a second valve is installed, the second valve being able to adopt a first position enabling coolant to circulate in the first channel and a second position preventing coolant from circulating in the first channel, said method comprising a step of heating a passenger compartment of the vehicle during which the four-way valve, the valve and the valve are each switched to the first position and cooling the passenger compartment of the vehicle during which the four-way valve, the valve first and the second valve are each switched to the second position.
